(19) United States
(12) Patent Application Publication
(10) Pub. No.: US 2026/0133910 A1
(43) Pub. Date: May 14, 2026

(54) CACHE ACCESS MANAGEMENT FOR RESILIENCY AND REDUNDANCY

(71) Applicant: INTERNATIONAL BUSINESS MACHINES CORPORATION, Armonk, NY (US)

(72) Inventors: Veeresh Jumanal, Bangalore (IN); Rizwan Sheikh Abdulla, Bangalore (IN); Shivarudrappa Satyanaik, Bengaluru (IN); Ravikishore Krishnamurthy, Bangalore (IN)

(21) Appl. No.: 18/941,175

(22) Filed: Nov. 8, 2024

(51) Int. Cl. G06F 12/0817

(52) U.S. Cl. CPC G06F 12/0828; G06F 2212/60

(57) ABSTRACT

Cache access management for resiliency and redundancy is provided by a method that establishes, by a host system hosting virtual machines, access to a network-accessible cache device provided by a remote system across a network between the host and remote systems. This provides access to the network-accessible cache device to virtual input/output (I/O) servers of the host system. The method virtualizes the network-accessible cache device into cache partitions of a cache pool of the host system. Each cache partition is assigned to cache data accessed by a respective virtual machine, and each of the virtual I/O servers has access to the cache partitions. The method also manages accesses to the cache partitions by the virtual I/O servers in handing access requests by the virtual machines. This management load-balances virtual machine access requests across virtual I/O servers and provides failover recovery to recover from a failed virtual I/O server.

### BACKGROUND

Aspects relate to providing resiliency and redundancy in a computing environment, and more specifically in the context of caching storage drives. It is common to use data caching in various computer systems, including systems that host virtual environments.

### SUMMARY

In accordance with aspects described herein, resiliency and redundancy are provided by caching storage drives using remote memory and managing accesses to a cache. Shortcomings of the prior art are overcome, and additional advantages are provided through the provision of a computer-implemented method. The method includes establishing, by a host system that hosts virtual machines, access to a network-accessible cache device. The network-accessible cache device is provided by a remote system across a network between the host system and the remote system. The establishing the access provides access to the network-accessible cache device to virtual input/output (I/O) servers of the host system. The method also includes virtualizing the network-accessible cache device into cache partitions of a cache pool of the host system. Each cache partition of the cache partitions is assigned to cache data accessed by a respective virtual machine of the virtual machines, and each of the virtual I/O servers has access to the cache partitions. The method further includes managing accesses to the cache partitions by the virtual I/O servers in handing access requests by the virtual machines to access the cache partitions. The managing load balances virtual machine access requests to access an assigned cache partition of the cache partitions across multiple virtual I/O servers of the virtual I/O servers, and provides failover recovery to recover from a failed virtual I/O server of the virtual I/O servers.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example host computer with data caching for hosted virtual machine(s);

FIG. 3 depicts an example computing environment to incorporate and/or use management of cache access by virtual input/output (I/O) servers in handling access requests to access cache partitions, in accordance with aspects described herein;

FIGS. 4A-4B depict further details of an example cache access management code of FIG. 1 to incorporate and/or use aspects described herein; and

FIGS. 5A-5B depict example processes for cache access management, in accordance with aspects described herein.

### DETAILED DESCRIPTION

Described herein are approaches for management of cache access, and specifically management of access by virtual input/output (I/O) servers to cache partitions in handling access requests by virtual machines of a host system to access cache partitions assigned to the virtual machines.

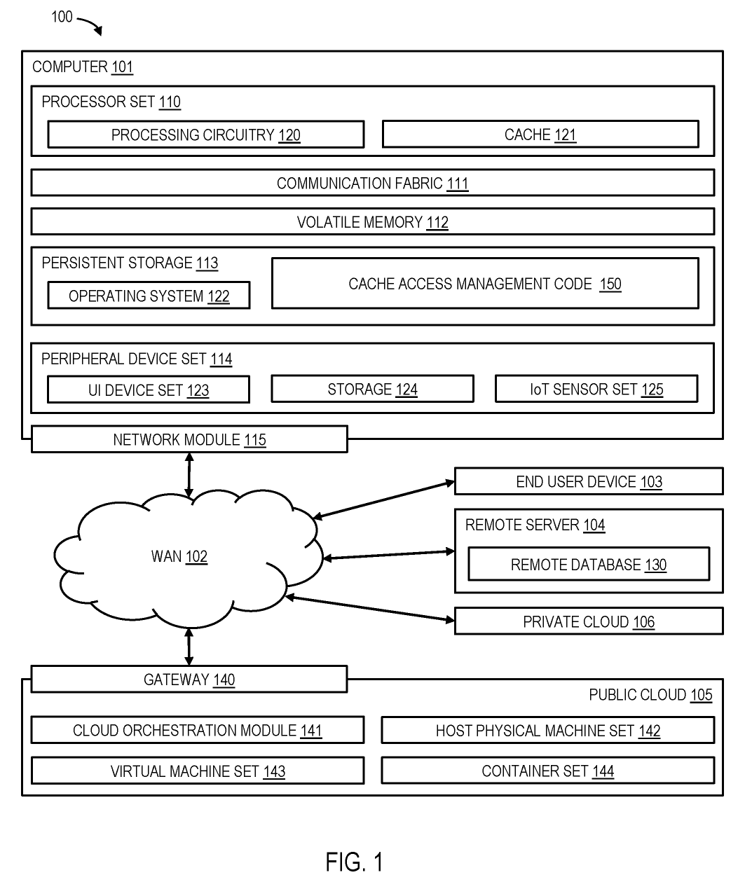

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cache access management code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

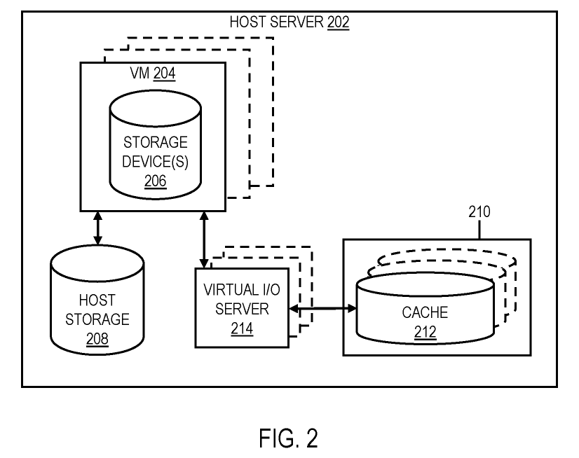

Initially, reference is made to FIG. 2, which depicts an example host computer system with data caching for hosted virtual machine(s). Referring to FIG. 2, a host computer system/server 202 hosts one or more virtual machines. Virtual machine 204 is shown and discussed by way of example. Virtual machine 204 has storage resource(s) 206 in the form of storage device(s), which may be referred to as a hard disk, partition, or the like. In some examples, such a storage device is backed by a physical disk of the host server 202, for instance host storage 208 as shown. In this situation, virtual machine 204 might, as part of its processing (execution) of a workload, for instance the hosting/running software application(s), access the host storage 208 to perform read/write operations – that is, to read from and/or write to its storage device 206 and therefore the host storage 208 backing the storage device 206. Since host storage such as 208 can be relatively slow in comparison to other storage, such as volatile memory, it is common practice to implement data caching. Data caching typically involves storing more frequently and/or recently accessed data, or data that is expected to be accessed relatively soon, into quicker storage, for instance volatile memory. Consequently, host server 202 includes a cache pool 210 of cache partition(s). Cache partition 212 is shown and discussed by way of example. Cache partition 212 is cache storage that is assigned to cache data being accessed (read from and/or stored to) host storage 208. Cache partition 212 may be a logical partition of a portion of system memory (not shown) of the host server 202, for instance of dynamic random access memory (DRAM) of the host server. DRAM-backed devices have relatively low latency and high data transfer rates, and hence are well-suited for caching disk data, for instance data stored on host storage 208.

In common scenarios, a given cache partition in the cache pool 210 is uniquely assigned to cache data that is accessed by a respective virtual machine. Thus, cache partition 212 may be a cache for caching data of storage device 206 of virtual machine 204, which is backed by relatively slow host storage 208. In this manner, cache partition 212 can cache at least some data that virtual machine 204 accesses from its storage device 206, in order to improve data access speed in comparison to accesses to the host storage 208. Other cache partition(s) can be assigned to other virtual machines, if present.

The host system also includes one or more virtual input/output (I/O server(s). Virtual I/O server(s) have access to cache partition(s) of the cache pool 210, and handle data access requests by the virtual machine(s) to access the cache partition(s). Virtual I/O server 214 is shown and discussed by way of example. Virtual I/O server 214 is responsible for handling access requests by virtual machine 204 to access cache partition 212 and potentially any other cache partition(s) assigned to virtual machine 204. Other virtual I/O servers may be provided to handle access requests by other virtual machines to access respective cache partitions assigned to them.

Meanwhile, virtual disk-based cache partitions backed by relatively fast memory like DRAM are possible for host environments. An example technology is virtual persistent memory (vPMEM), in which data persistency in DRAM is guaranteed at the virtual machine level, and the memory can be accessed as a block device. Various cache disks/partitions can be established from the DRAM as logical devices presented via the virtual I/O servers to the virtual machines of the system. A cache disk/partition for data I/O can be created for each virtual I/O server, and can be private to that particular virtual I/O server and used for caching storage device(s) of a given virtual machine. In this manner, for any given virtual I/O server, the virtual I/O server is responsible for its associated cache partitions of the cache pool and is not responsible for other cache partitions of the cache pool. Thus, there may be a mapping/assignment of a cache partition to a virtual machine and a given virtual I/O server sitting between the virtual machine and the virtual I/O server. In the example of FIG. 2, virtual machine 204 has storage device(s) 206 for which there is memory (i.e., cache partition 212) acting as a cache, and cache partition 212 is backed by DRAM of the host server 202. In some examples, the virtual I/O servers maintain the cache pool, though the cache pool could, in other examples, be managed by an overriding management entity.

It is noted that a storage device of a virtual machine need not necessarily be associated with host storage 208 (meaning stored to a hard disk or other non-volatile storage); in some examples, a storage device 206 of a virtual machine could be provided directly from the corresponding virtual I/O server as a virtual disk that is essentially just storage to cache memory. In any case, aspects described herein to manage cache access apply to this scenario as well.

Problems exist with respect to the arrangement described above that utilizes virtualized cache devices that are private in nature, as this arrangement fails to maintain high availability, disaster recovery, and load balancing capabilities. For example, if a virtual I/O sever goes down or in another way fails such that it cannot handle cache data accesses, the underlying virtual machine loses the ability for data accesses to be made to/from the assigned the cache partition of the cache pool, and in some cases that cache data could be lost altogether. In this respect, it is desired to provide a failover recovery in situations of virtual I/O server failure. Furthermore, isolating the responsibility for accessing a given cache partition to a given virtual I/O server can negatively affect performance in accessing that cache partition in the event that the virtual I/O server becomes overloaded. If a given virtual I/O server has a relatively high workload due to the cache partition(s) it services, while another virtual I/O server has a relatively low due to access the cache partition(s) it services, then the resulting utilization of the two virtual I/O servers is not in balance. This can be undesirable, particularly when performance degradation of the over-utilized virtual I/O server results. It is desired to provide load balancing capabilities to load-balance the handling of virtual machine access requests to a given cache partition across multiple, meaning two or potentially more, virtual I/O servers of those provided in the system.

Aspects described herein provide facilities to address failover and load balance issued noted above by leveraging cache-coherent communication over a network interconnect protocol. In particular, aspects provide virtualized cache devices backed by storage over a network using a cache-coherent network interconnect protocol between (i) virtual I/O servers of a target system and (ii) a source system providing a network-accessible cache device. The Compute Express Link (CXL) standard, as an example, can be leveraged to provide an example cache-coherent network interconnect protocol (‘CXL over network’).

In some aspects, access to a cache partition is shared among virtual I/O servers to enable high availability, disaster recovery, and load balancing across them. In other words, a collection (two or more) virtual I/O servers of the target system can have access to the cache partition such each of the virtual I/O servers are capable of servicing requests from a virtual machine to access data stored in the cache partition. Aspects can be particularly beneficial for cloud environments in which recovery from failover and load balancing of cache devices is desired.

Thus, in some aspects, approaches are provided to share a memory across network-connected systems, e.g., a source system and target system in cloud environment, to cache hard disks of virtual machines. Memory sharing can be achieved through a high-speed interconnect designed to provide cache-coherent communication. Example cache coherent protocol(s) includes CXL over the network and Open Coherent Accelerator Processor Interface (Open CAPI). In examples, memory is shared from one system to another system present in a cloud environment through a bus that provides cache-coherent network communication. CXL and Open CAPI, as examples, provide standards for cache-coherent interconnection to provide a high-speed, low-latency connection between two devices. One device can be a host system and another device can be another system or an accelerator (as examples) to which another memory or storage class device is connected.

In examples, a host system obtains access to a DRAM-backed single disk from a remote system (also referred to as a source system) through a CXL, and the disk is shared among virtual I/O servers. The disk can be used as a network-accessible cache device that is virtualized to create a cache pool of cache partitions that may be shared among underlying virtual machines by way of these virtual I/O servers. Each virtual I/O server of a group (two or more) of virtual I/O servers of the host system may access, and be capable of handling data requests for, one or more of the cache partitions, thus enabling the virtual I/O servers to be managed to selectively handle virtual machine access requests to access the data of those cache partitions. Similarly, I/O bandwidth may be shared between the virtual I/O severs to enable load balancing and failover recovery in the event that a virtual I/O server handling some access requests by a virtual machine to access a cache partition fails or becomes overloaded. In this manner, a given virtual I/O server may handle access requests to access multiple different cache partitions on behalf of different virtual machines.

The management of the virtual I/O server accesses to the cache partitions can therefore include load balancing and failover recovery. The management may be performed in whole or in part by any of various entities, including, but not limited to the virtual I/O servers themselves and/or a dedicated management component. There could be management component(s) with load balancing and/or failover recovery program code/logic, for instance, to control which virtual I/O server handles which access requests for data input/output. In some examples, such management component(s) are part of one or more of the virtual I/O servers of the host system. The virtual I/O servers could, for example, communicate and have an agreed-upon approach for managing accesses to the cache partitions. This could be supported by communication between the virtual I/O servers to share heartbeat, handshake and/or other information. For instance, if a virtual I/O server goes down and therefore fails to send a heartbeat signal to other virtual I/O server(s), the other virtual I/O servers can perform activity to manage a transition in which virtual I/O server(s) handle the access requests in place of the failing virtual I/O server. Similarly, information about current loads of the virtual I/O servers can be shared and used to determine whether access request handling workload should be rearranged among multiple (two or more) of the virtual I/O servers.

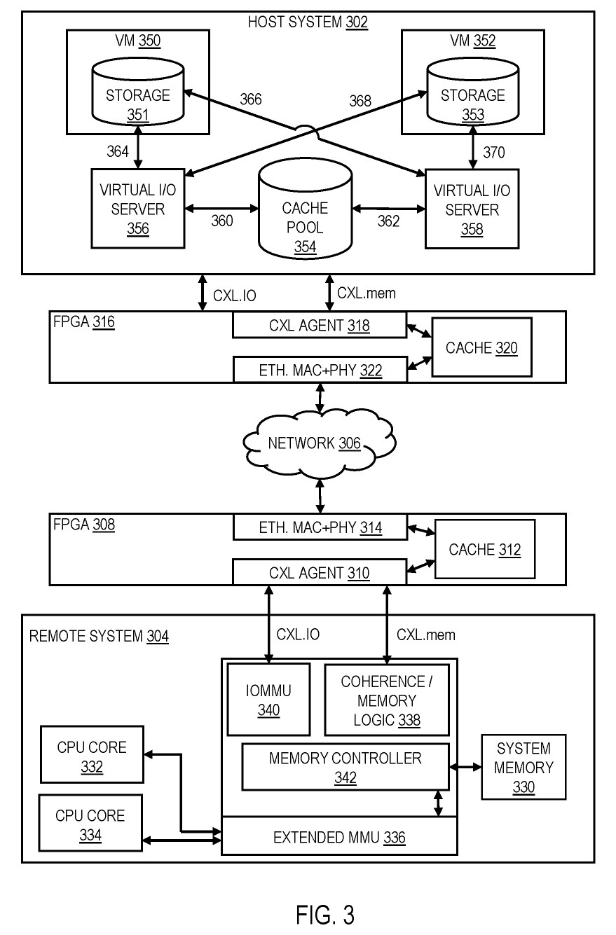

Further embodiments and aspects are described with reference to FIG. 3, depicting an example computing environment to incorporate and/or use management of cache access by virtual input/output (I/O) servers in handling access requests to access cache partitions, in accordance with aspects described herein. Shown are a host system 302 (also referred to as a target system) and remote system 304 (also referred to as a source system). The remote system 304 provides a network-accessible cache device – it is the source of the device – and the host system 302 is given access to the network-accessible cache device across a network 306.

Remote system 304 has physical, local connectivity to network 306 via field-programmable gate array (FPGA) 308. Remote system 304 communicates with network 306 via FPGA 308 using one or more CXL-based protocol(s) in this example, as a cache-coherent network interconnect protocol. For instance, shown is remote system 304 communicating with a CXL agent 310 of FPGA 308 using the CXL.mem and CXL.io protocols. FPGA 308 provides a connection to network 306 and includes a cache component 312 and Ethernet components 314, which include Media Address Control (MAC) and physical components for network connectivity.

Similarly, host system 302 has physical, local connectivity to network 306 via FPGA 316 and communicates with network 306 via FPGA 316 using one or more CXL-based protocol(s) in this example, as a cache-coherent network interconnect protocol. For instance, shown is host system 302 communicating with a CXL agent 318 of FPGA 316 using the CXL.mem and CXL.io protocols. FPGA 316 provides a connection to network 306 and includes a cache component 320 and Ethernet components 322, which include Media Address Control (MAC) and physical components for network connectivity.

Remote system 304 includes various components, including system memory 330, which may be DRAM or Non-Volatile Memory Express (NVMe) memory as non-limiting examples, to provide the network-accessible cache device. Shown also as part of remote system 304 are central processing unit (CPU) cores 332 and 334 that communicate with an extended memory management unit (MMU) 336 having coherence/memory logic 338, an I/O memory management unit (IOMMU) 340, and memory controller 342 that communicates with system memory 330. The coherence/memory logic 338 and IOMMU 340 communicate with CXL agent 310 via the CXL.mem and CXL.io protocols, respectively, to provide cache-coherent communication on the source side over the network 306.

Host system 302 may be a host system, such as one similar to the host system described with reference to FIG. 2 that hosts virtual machines and implements caching. In the example of FIG. 3, host system 302 includes virtual machines 350 and 352 having storage devices 351 and 353, respectively, a cache pool 354 of cache partitions (not individually shown), and virtual I/O servers 356 and 358. Virtual I/O servers 356 and 358 have access to cache partitions of cache pool 354 via their respective communications paths 360 and 362 to the cache pool. Thus, cache pool 354 can include (at least) two cache partitions – a first cache partition assigned to cache data accessed by virtual machine 350 and a second cache partition to cache data accessed by virtual machine 352, and virtual I/O servers 356 and 358 can each have access to both of these cache partitions. This enables virtual I/O server 356 to handle access request(s) by virtual machine 350 to access its assigned cache partition(s) of the cache pool 354, as shown by the communication path 364, and enables virtual I/O server 358 to handle access request(s) by virtual machine 350 to access its assigned cache partition(s) of the cache pool 354, as shown by the communication path 366. Similarly, it enables virtual I/O server 356 to handle access request(s) by virtual machine 352 to access its assigned cache partition(s) of the cache pool 354, as shown by the communication path 368, and enables virtual I/O server 358 to handle access request(s) by virtual machine 352 to access its assigned cache partition(s) of the cache pool 354, as shown by the communication path 370. Accesses to the cache partitions by the virtual I/O servers in handing access requests by the virtual machines to access the cache partitions can thereby be managed, for instance to load-balance virtual machine access requests, which are requests to access an assigned cache partition of the cache partitions, across multiple virtual I/O servers of the virtual I/O servers, and to provide failover recovery to recover from a failed virtual I/O server of the virtual I/O servers, as described herein.

Although only two virtual machines are depicted in the example of FIG. 3, the host system could host a greater number of virtual machines, and aspects described herein are not limited to situations in which only two virtual machines access the cache pool. Similarly, although only two virtual I/O server are depicted in the example of FIG. 3, the host system could include a greater number of virtual I/O servers, and aspects described herein are not limited to situations in which only two virtual I/O servers handle requests from the virtual machines of the system.

An example sequence of events is now described for providing management of cache access, and specifically management of access by virtual input/output (I/O) servers to cache partitions in handling access requests by virtual machines of a host system to access cache partitions assigned to the virtual machines.

Initially, remote memory is identified and configured through, e.g., CXL. For instance, a process identifies a source system that can share the memory, creates a virtual persistent disk, and shares it across the network. The virtual persistent disk may be shared across a network using protocol(s) providing cache-coherent communication over a network, thus providing a network-accessible cache device. In examples, the provided network-accessible cache device includes dynamic random access memory of the remote system.

As noted, examples can leverage CXL as the cache-coherent protocol. CXL can interface with FPGAs, as an example, for necessary address translations, and CXL uses Ethernet to transmit CXL remote memory access requests to access remote memory with native memory semantics. Known CXL protocols include CXL.io, CXL.mem, and CXL.cache. CXL.io can be used to map FPGA-network attached memory to the host memory address space through the IOMMU and based on a physical memory address range. The Extended MMU can determine the control unit that can process memory read/write requests using the CXL.mem protocol. CXL.cache can define interactions between a host and a device to allow the device to coherently access and cache data with low latency.

With the remote memory available, network configuration can proceed with connecting the target system (e.g., host 302) through the network to the source system (remote system 304) capable of sharing the virtual persistent disk. The network connection can be a multiport connection used to read from and write to the source system’s memory over the cache-coherent interconnection by accessing a unique network identifier by the host system. In this regard, the virtual persistent disk can have a unique network identifier for use in mapping to access the disk across the network. Upon accessing the disk using the identifier, read and write operations can be performed. The multiport network connection can be assigned to two or more virtual I/O servers of the host system for communication to support multiple connections between the virtual I/O servers on the host system, through the network adapter, and to the source system.

In this manner, the source/remote system can present disk(s) to the host/target system. Thus, the host system establishes access to the network-accessible cache device (e.g., virtual persistent disk), which is provided by the remote system across the network between the host system and the remote system. Establishing this access provides access to the network-accessible cache device to virtual I/O servers of the host system. The provided network-accessible cache device may be presented to the host system via a cache-coherent network interconnect protocol, such as CXL.

Once registered, presented disk(s), which might initially be free (empty) disk drives, can be divided into multiple cache partitions (or “cache disks”) as part of a cache pool of the host system. For instance, processing on the host system can virtualize the network-accessible cache device into cache partitions of a cache pool of the host system, where each cache partition of the cache partitions is assigned to cache data accessed by a respective virtual machine of the virtual machines, and each of the virtual I/O servers has access to the cache partitions. In this regard, each of the virtual I/O servers can have the capability, and be configured, to access each of the cache partitions. In a specific example, the cache pool can be filled by the virtual I/O server(s) using the virtual persistent disk to create cache partitions for use.

The cache partitions derived out of the remote system’s memory through cache-coherent communication over the network interconnect protocol can be assigned to virtual machines for caching data of the hard disk drives of the virtual machines. For instance, for each virtual machine for which disk caching is enabled, a cache partition of the cache pool can be assigned to the virtual machine. Since the cache partition is accessible by more than one virtual I/O server via the multipath connection, this facilitates managing cache access, for instance to provide load balancing and failover recovery for cache disks.

Specifically, functionality can manage how accesses to the cache partitions are handled, especially in load balancing and/or failover scenarios. A process can manage accesses, e.g., data I/O operations like reads and writes, to the cache partitions by the virtual I/O servers in their handing of access requests by the virtual machines to access the cache partitions. The managing can, for instance, load balance, across multiple (i.e., two more) virtual I/O servers of the virtual I/O servers of the system, virtual machine access requests to access an assigned cache partition of the cache partitions, and can provide failover recovery to recover from a failed virtual I/O server of the virtual I/O servers.

In one example of this management, there may be a transition, from one virtual I/O server to another virtual I/O server, in the handling of at least some access requests being made to a cache partition. For instance, a first virtual I/O server might initially be identified for handling all, or at least some, of the data access requests being made by a virtual machine, which data access requests are for data in a cache partition assigned to the virtual machine. A determination may be made to transition some or all of that handling to a second virtual I/O server, meaning to transition handling of existing or future access requests for data in the cache partition assigned to the virtual machine. Therefore, a process could determine to transition, and then actually transition, the handling of at least some access requests, which are made by one virtual machine of the virtual machines to a cache partition assigned to the one virtual machine, from a first virtual I/O server of the virtual I/O servers to a second virtual I/O server of the virtual I/O servers. In some examples, that second virtual I/O server could be one that is already handling access requests by another virtual machine of the virtual machines to a different cache partition assigned to that other virtual machine. In this manner, at least some of the workload to handle access requests of the one virtual machine can be transitioned to the second virtual I/O server that is already handling other access requests of another virtual machine utilizing another cache partition.

As noted, a transition determination could be made based on heart-beating and/or handshaking that occurs between the virtual I/O servers and/or other management component(s). The exchanged information could inform whether and when to transition. In some examples, the determination to transition is made by one or more of the virtual I/O servers based on the exchanged heartbeat information, for instance.

The transition might occur as part of recovery from a virtual I/O server failure, i.e., as a failover transition. In this aspect, the determination to transition can include recognizing a failure of a first virtual I/O server, and the transitioning (for instance to transition the handling over to a second virtual I/O server) can be performed automatically based on that. With multiple paths to access a cache partition that is accessed by the failing virtual I/O server, the multiple paths referring to the ability for each of a plurality of virtual I/O servers (including the failing virtual I/O server) to access the cache partition, failure of the first virtual I/O sever can be detected based on a failure of the first virtual I/O server to provide a heartbeat packet or other information. Another virtual I/O server, or another component, can detect the failure to receive the heartbeat packet (or other information) and determine to transition the handling of access requests, for instance read/write operations to the involved cache partition, that would otherwise be handled by that failing virtual I/O server to instead be handled by a second virtual I/O server via its alternate path to the cache partition.

Additionally or alternatively, a transition might occur as part of a load balancing transition. In this aspect, the determination to transition can include detecting any workload-dependent trigger, for instance recognizing that a workload of a first virtual I/O server exceeds a threshold, and the transitioning can be performed automatically based on that determining. In examples, the recognition of whatever trigger is used, for example the workload exceeding the threshold, can be made based on information provided from any of various sources, for instance from the first virtual I/O server itself, or from a virtual machine that is the source of access requests. The first virtual I/O server might report that it is overloaded, for instance, or a virtual machine might report problems like the response time from its current virtual I/O server being too high, for instance. In these situations, some or all of the access request handling that would otherwise be performed by the first virtual I/O server could be transitioned to being handled by the second virtual I/O server in that case. Since the cache partition can be accessed by two or more virtual I/O servers via multiple paths, read/write bandwidth can be shared between those two or more virtual I/O servers, and if one of the virtual I/O servers becomes overloaded, then load balancing across a group (two or more) of virtual I/O servers can occur to maintain a desired quality of service. In examples, portions of the load handled by a given virtual I/O server are load-balanced across three or more virtual I/O servers.

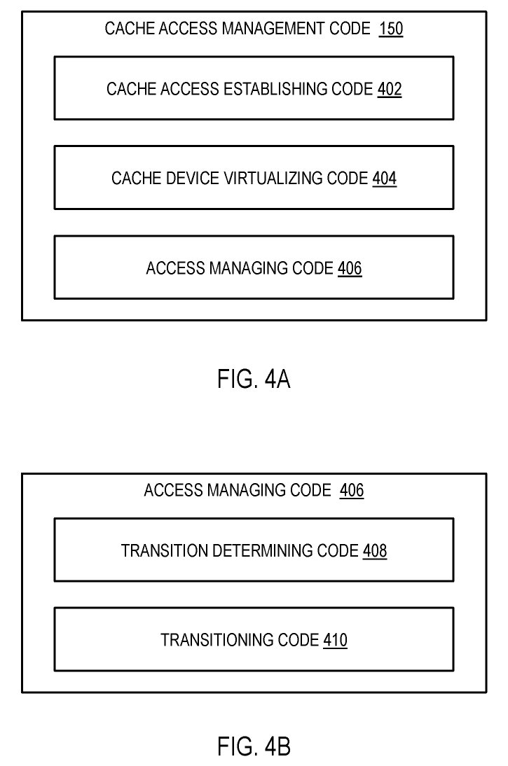

FIGS. 4A-4B depict further details of example cache access management code (e.g., cache access management code 150 of FIG. 1) to incorporate and/or use aspects described herein. In one or more aspects, cache access management code 150 includes, in one example, various sub-modules to be used to perform cache access management. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring initially to FIG. 4A, cache access management code 150 includes cache access establishing code 402 to establish access to a network-accessible cache device, cache device virtualizing code 404 to virtualize the network-accessible cache device into cache partitions of a cache pool, and access managing code 406 to manage accesses to cache partitions by virtual I/O servers. FIG. 4B depicts example sub-code/modules of access managing code 406 to manage accesses to cache partitions by virtual I/O servers. Referring to FIG. 4B, access managing code 406 includes transition determining code 408 to determine to transition handling of access requests, by one virtual machine to a cache partition assigned to the one virtual machine, from one virtual I/O server to another virtual I/O, and transitioning code 410 to transition the handling of the access requests to the other virtual I/O server.

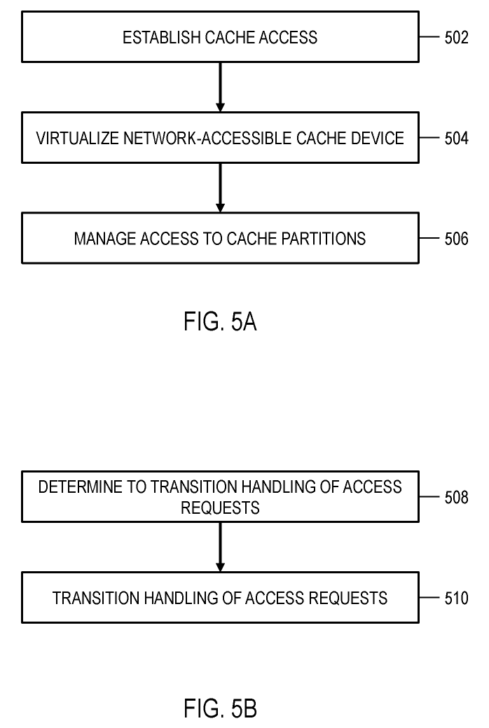

FIGS. 5A-5B depict example processes for cache access management, in accordance with aspects described herein. The process may be executed, in one or more examples, by a processor or processing circuitry of one or more computers/computer systems, such as those described herein, and more specifically those described with reference to FIGS. 1 or 3 . In examples, the processes are performed by a host system, and specifically one or more executing components of a host system, for instance a hypervisor of the host system, an executing separate management component of the host system, and/or one or more virtual I/O servers of the host system. In examples, code or instructions implementing the process(es) of FIGS. 5A-5B are part of a module, such as code module 150. In other examples, the code may be included in one or more code modules and/or in one or more code sub-modules of the one or more modules. Various options are available.

Referring to FIG. 5A, the process includes establishing (502), by the host system that hosts virtual machines, access to a network-accessible cache device. The network-accessible cache device is provided by a remote system across a network between the host system and the remote system, and the establishing the access provides access to the network-accessible cache device to virtual input/output (I/O) servers of the host system. In examples, the provided network-accessible cache device includes dynamic random access memory of the remote system. In some embodiments, the provided network-accessible cache device is presented to the host system via a cache-coherent network interconnect protocol, such as CXL or Open CAPI. The process of FIG. 5A also includes virtualizing (504) the network-accessible cache device into cache partitions of a cache pool of the host system. Each cache partition of the cache partitions is assigned to cache data accessed by a respective virtual machine of the virtual machines, and each of the virtual I/O servers has access to the cache partitions. Further, the process of FIG. 5A includes managing accesses (506) to the cache partitions by the virtual I/O servers in handing access requests by the virtual machines to access the cache partitions. The managing at least (i) load balances virtual machine access requests to access an assigned cache partition of the cache partitions across multiple virtual I/O servers of the virtual I/O servers, and (ii) provides failover recovery to recover from a failed virtual I/O server of the virtual I/O servers.

FIG. 5B depicts an example process for managing access (506) to cache partitions, and includes determining (508) to transition handling of at least some access requests, by one virtual machine of the virtual machines to a cache partition assigned to the one virtual machine, from one virtual I/O server of the virtual I/O servers to another virtual I/O server of the virtual I/O servers. In examples, the other virtual I/O server also handles access requests by another virtual machine of the virtual machines to a cache partition assigned to the other virtual machine. Based on this determination to transition, the process of FIG. 5B also includes transitioning the handling of the at least some access requests to the another virtual I/O server.

In a specific example, the transition is a failover transition, the determining (508) to transition includes recognizing a failure of the one virtual I/O server, and the transitioning (510) is performed automatically based on the determining (508).

In another specific example, the transition is a load balancing transition, the determining (508) to transition includes recognizing that a workload of the one virtual I/O server exceeds a threshold, and the transitioning (510) is performed automatically based on the determining (508). In yet a further embodiment, the recognizing that the workload exceeds the threshold is based on information provided from the one virtual machine, the one virtual I/O server, or a combination of the two. In some embodiments, the virtual I/O servers exchange heartbeat information, and the determining (508) to transition is made by at least one virtual I/O server of the virtual I/O servers based on the exchanged heartbeat information.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method including:
establishing, by a host system that hosts virtual machines, access to a network-accessible cache device, wherein the network-accessible cache device is provided by a remote system across a network between the host system and the remote system, and wherein the establishing the access provides access to the network-accessible cache device to virtual input/output (I/O) servers of the host system;
virtualizing the network-accessible cache device into cache partitions of a cache pool of the host system, wherein each cache partition of the cache partitions is assigned to cache data accessed by a respective virtual machine of the virtual machines, and each of the virtual I/O servers has access to the cache partitions; and
managing accesses to the cache partitions by the virtual I/O servers in handing access requests by the virtual machines to access the cache partitions, wherein the managing load balances virtual machine access requests to access an assigned cache partition of the cache partitions across multiple virtual I/O servers of the virtual I/O servers, and provides failover recovery to recover from a failed virtual I/O server of the virtual I/O servers.

2. The method of claim 1, wherein the managing includes:
determining to transition handling of at least some access requests by one virtual machine of the virtual machines to a cache partition assigned to the one virtual machine from one virtual I/O server of the virtual I/O servers to another virtual I/O server of the virtual I/O servers, the another virtual I/O server also handling access requests by another virtual machine of the virtual machines to a cache partition assigned to the another virtual machine; and
transitioning the handling of the at least some access requests to the another virtual I/O server.

3. The method of claim 2, wherein the determining to transition includes recognizing a failure of the one virtual I/O server, and wherein the transitioning is performed automatically based on the determining.

4. The method of claim 2, wherein the determining to transition includes recognizing that a workload of the one virtual I/O server exceeds a threshold, and wherein the transitioning is performed automatically based on the determining.

5. The method of claim 4, wherein the recognizing is based on information provided from at least one selected from the group consisting of the one virtual machine and the one virtual I/O server.

6. The method of claim 2, wherein the virtual I/O servers exchange heartbeat information, and wherein the determining to transition is made by at least one virtual I/O server of the virtual I/O servers based on the exchanged heartbeat information.

7. The method of claim 1, wherein the provided network-accessible cache device includes dynamic random access memory of the remote system.

8. The method of claim 1, wherein the provided network-accessible cache device is presented to the host system via a cache-coherent network interconnect protocol.

9. A computer system including:
at least one computing device;
a set of one or more computer readable storage media; and
program instructions, collectively stored in the set of one or more computer readable storage media, for causing the at least one computing device to perform computer operations including:
establishing, by a host system that hosts virtual machines, access to a network-accessible cache device, wherein the network-accessible cache device is provided by a remote system across a network between the host system and the remote system, and wherein the establishing the access provides access to the network-accessible cache device to virtual input/output (I/O) servers of the host system;
virtualizing the network-accessible cache device into cache partitions of a cache pool of the host system, wherein each cache partition of the cache partitions is assigned to cache data accessed by a respective virtual machine of the virtual machines, and each of the virtual I/O servers has access to the cache partitions; and
managing accesses to the cache partitions by the virtual I/O servers in handing access requests by the virtual machines to access the cache partitions, wherein the managing load balances virtual machine access requests to access an assigned cache partition of the cache partitions across multiple virtual I/O servers of the virtual I/O servers, and provides failover recovery to recover from a failed virtual I/O server of the virtual I/O servers.

10. The computer system of claim 9, wherein the managing includes:
determining to transition handling of at least some access requests by one virtual machine of the virtual machines to a cache partition assigned to the one virtual machine from one virtual I/O server of the virtual I/O servers to another virtual I/O server of the virtual I/O servers, the another virtual I/O server also handling access requests by another virtual machine of the virtual machines to a cache partition assigned to the another virtual machine; and
transitioning the handling of the at least some access requests to the another virtual I/O server.

11. The computer system of claim 10, wherein the determining to transition includes recognizing a failure of the one virtual I/O server, and wherein the transitioning is performed automatically based on the determining.

12. The computer system of claim 10, wherein the determining to transition includes recognizing that a workload of the one virtual I/O server exceeds a threshold, and wherein the transitioning is performed automatically based on the determining.

13. The computer system of claim 12, wherein the recognizing is based on information provided from at least one selected from the group consisting of the one virtual machine and the one virtual I/O server.

14. The computer system of claim 9, wherein the provided network-accessible cache device includes dynamic random access memory of the remote system, and wherein the provided network-accessible cache device is presented to the host system via a cache-coherent network interconnect protocol.

15. A computer program product including:
a set of one or more computer readable storage media; and
program instructions, collectively stored in the set of one or more computer readable storage media, for causing at least one computing device to perform computer operations including:
establishing, by a host system that hosts virtual machines, access to a network-accessible cache device, wherein the network-accessible cache device is provided by a remote system across a network between the host system and the remote system, and wherein the establishing the access provides access to the network-accessible cache device to virtual input/output (I/O) servers of the host system;
virtualizing the network-accessible cache device into cache partitions of a cache pool of the host system, wherein each cache partition of the cache partitions is assigned to cache data accessed by a respective virtual machine of the virtual machines, and each of the virtual I/O servers has access to the cache partitions; and
managing accesses to the cache partitions by the virtual I/O servers in handing access requests by the virtual machines to access the cache partitions, wherein the managing load balances virtual machine access requests to access an assigned cache partition of the cache partitions across multiple virtual I/O servers of the virtual I/O servers, and provides failover recovery to recover from a failed virtual I/O server of the virtual I/O servers.

16. The computer program product of claim 15, wherein the managing includes:
determining to transition handling of at least some access requests by one virtual machine of the virtual machines to a cache partition assigned to the one virtual machine from one virtual I/O server of the virtual I/O servers to another virtual I/O server of the virtual I/O servers, the another virtual I/O server also handling access requests by another virtual machine of the virtual machines to a cache partition assigned to the another virtual machine; and
transitioning the handling of the at least some access requests to the another virtual I/O server.

17. The computer program product of claim 16, wherein the determining to transition includes recognizing a failure of the one virtual I/O server, and wherein the transitioning is performed automatically based on the determining.

18. The computer program product of claim 16, wherein the determining to transition includes recognizing that a workload of the one virtual I/O server exceeds a threshold, and wherein the transitioning is performed automatically based on the determining.

19. The computer program product of claim 18, wherein the recognizing is based on information provided from at least one selected from the group consisting of the one virtual machine and the one virtual I/O server.

20. The computer program product of claim 15, wherein the provided network-accessible cache device includes dynamic random access memory of the remote system, and wherein the provided network-accessible cache device is presented to the host system via a cache-coherent network interconnect protocol.
